(19) United States
(12) Patent Application Publication
(10) Pub. No.: US 2025/0377029 A1
(43) Pub. Date: Dec. 11, 2025

(54) APPARATUS FOR DRUM BRAKE ASSEMBLY

(71) Applicants: ZF Active Safety US Inc., Livonia, MI (US); ZF Friedrichshafen AG, Friedrichshafen (DE); ZF Active Safety GmbH, Koblenz (DE); ZF Automotive Brasil Ltda., Limeira (BR)

(72) Inventors: Thomas Schwegler, Tettnang (DE); Detlef Baasch, Oberteuringen (DE); Andreas Knoll, Lindau (DE); Marc Schieß, Hohenfels (DE); Martin Ruider, Schwarzhofen (DE); Ingo Decker, Friedrichshafen (DE); Galus Chelaidite, South Lyon, MI (US); Lukas Madzgalla, Lahnstein (DE); Rui Bertim de Campos, Limeira (BR); Michael Pantke, Friedrichshafen (DE); Nico Rueß, Meckenbeuren (DE); Tobias Stanger, Attenweiler (DE); Michael Huber, Langenargen (DE)

(21) Appl. No.: 18/739,688

(22) Filed: Jun. 11, 2024

(51) Int. Cl. F16D 65/22; F16D 121/24; F16D 125/36; F16D 125/50; F16D 127/06

(52) U.S. Cl. CPC F16D 65/22; F16D 2121/24; F16D 2125/36; F16D 2125/50; F16D 2127/06

(57) ABSTRACT

An apparatus for a brake drum having a drum brake assembly with first and second brake shoes includes a motor and a planetary gear train for receiving torque from the motor and having an output gear. A ball ramp assembly receives torque from the output gear and has ends aligned with the respective first and second brake shoes. The motor is actuatable for lengthening the ball ramp assembly to move the brake shoes and apply braking force to the brake drum. A bi-stable locking mechanism selectively locks the planetary gear train to apply a parking brake to the brake drum.

### TECHNICAL FIELD

The present invention relates generally to braking systems, and specifically to a brake pad actuator for a drum brake assembly.

### BACKGROUND

Drum brakes are typically provided on the rear wheels of vehicles in order to braking to the vehicle wheels. The brakes include brake shoes selectively movable away from one another and into engagement with the brake drum to apply braking force to the brake drum via the friction material bonded to each brake shoe. The brake shoes are locked in this position to apply and hold the brake until released by the vehicle operator.

### SUMMARY

In one aspect of the invention, an apparatus for a brake drum having a drum brake assembly with first and second brake shoes includes a motor and a planetary gear train for receiving torque from the motor and having a pinion gear. A ball ramp assembly receives torque from the pinion gear and has ends aligned with the respective first and second brake shoes. The motor is actuatable for lengthening the ball ramp assembly to move the brake shoes and apply braking force to the brake drum. A bi-stable locking mechanism selectively locks the planetary gear train to apply a parking brake to the brake drum.

In another aspect, an apparatus for a drum brake assembly having first and second brake shoes includes a motor. A planetary gear train receives torque from the motor and has an output gear. A guide is fixed relative to the planetary gear train and includes a radial opening aligned with the output gear. A ball ramp assembly is provided in the guide and has a nut for receiving torque from the output gear and a spindle. The nut is aligned with the first brake shoe and the spindle is aligned with the second brake shoe. The motor is actuatable for rotating the nut to move the nut and the spindle away from one another for engaging the brake shoes to apply braking force to the brake drum. A bi-stable locking mechanism has a first condition engaging the planetary gear train for locking the same in response to receiving electrical power of a first polarity and having a second condition retracted from the planetary gear train for allowing rotation of the same in response to receiving electrical power of a second polarity.

Other objects and advantages and a fuller understanding of the invention will be had from the following detailed description and the accompanying drawings.

### BRIEF DESCRIPTION OF THE DRAWINGS

FIG. 1 is a schematic illustration of a vehicle having a drum brake assembly in accordance with an aspect of the present invention.

FIG. 2 is a schematic illustration of a brake drum of the drum brake assembly.

FIG. 3 is a schematic illustration of an example brake shoe actuation device prior to performing a braking event.

FIG. 4 is an enlarged view of a portion of FIG. 3.

FIG. 5 is a schematic illustration of the actuation device when a service brake operation is performed.

FIG. 6 is a schematic illustration of the actuation device automatically adjusting in response to wear on the brake shoes.

FIG. 7 is a schematic illustration of the actuation device applying a parking brake.

FIG. 8 is a schematic illustration of another actuation device prior to performing a braking event.

FIG. 9 is a schematic illustration of the actuation device of FIG. 8 when service braking is performed.

FIG. 10 is a schematic illustration of the actuation device of FIG. 8 automatically adjusting in response to wear on the brake shoes.

### DETAILED DESCRIPTION

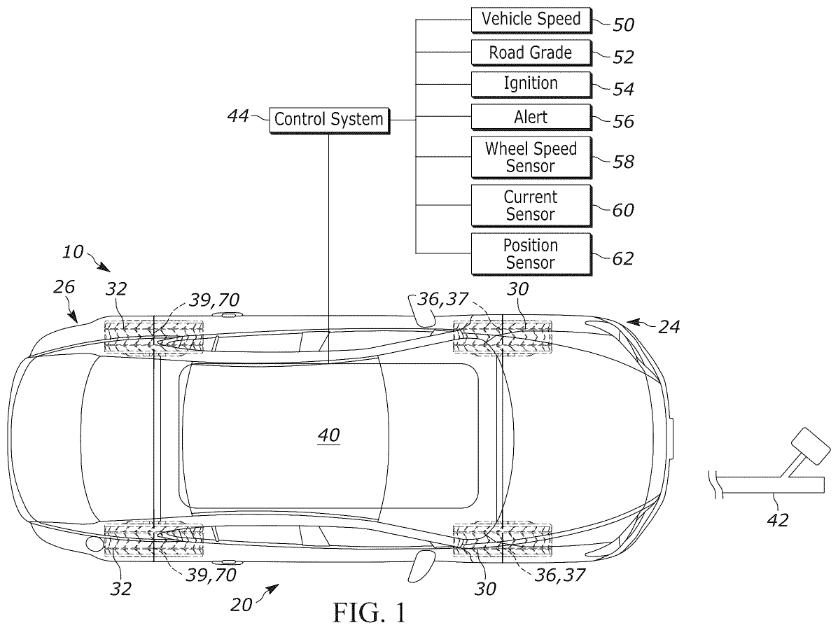

The present invention relates generally to service braking systems, and specifically to a brake shoe actuation device for a drum brake assembly. FIG. 1 illustrates an example electric brake/braking system 10 for a motor vehicle 20 in accordance with the present invention.

The vehicle 20 extends from a first or front end 24 to a second or rear end 26. A pair of steerable wheels 30 is provided at the front end 24. Each wheel 30 includes a wheel drum 36 driven and steered by a steering linkage (not shown). Disc brakes 37 are associated with each wheel drum 36. A brake pedal 42 can be used to actuate the disc brakes 37 to apply service braking to the wheels 30.

A pair of steerable or non-stecrable wheels 32 is provided at the rear end 26. As shown, cach rear wheel 32 includes a brake drum (not shown) driven by a steering linkage (not shown). Service brake electromechanical drum brake assemblies 39, henceforth referred to as “eDrum”, e.g., drum brake assemblies, are associated with each drum. It will be appreciated that the eDrum 39 could alternatively or additionally by used on the wheels 30 in lieu of the disc brakes 37. A propulsion system 40, e.g., an engine and/or battery, supplies torque to the wheels 30.

A control system 44 is provided to help control operation of the vehicle 20, such as operation of the propulsion system 40 and vehicle braking, including operation of the parking brake function of the eDrum 39. To this end, the control system 44 can include one or more controllers, such as a propulsion system controller, motor controller, and/or brake controller. That said, the control system 44 is connected to and receives signals from various sensors that monitor vehicle functions and environmental conditions.

For example, a vehicle speed/acceleration sensor 50 monitors the vehicle speed and acceleration and generates signals indicative thereof. A road grade sensor 52 can detect or calculate the slope of the road on which the vehicle 20 is driving and generate signals indicative thereof. An ignition sensor 54 generates signals indicative of ignition status. A wheel speed sensor 58 is provided on/adjacent to each wheel 32 and generates signals indicative of the speed at each wheel. The control system 44 also receives signals indicative of the degree-including velocity and acceleration-the brake pedal 42 is depressed.

The control system 44 can receive and interpret these signals and perform vehicle functions, e.g., braking, in response thereto. In one example, the control system 44 can detect wheel slip between one or more wheels 30, 32 and the driving surface based on the sensors 50, 58 and perform anti-lock braking (ABS) and/or electronic stability control (ESC) using one or more disc and/or drum brakes 37. The control system 44 can also be connected to an alert 56 for notifying the driver/operator of the vehicle 20 of vehicle conditions, vehicle status, braking events, and/or environmental conditions.

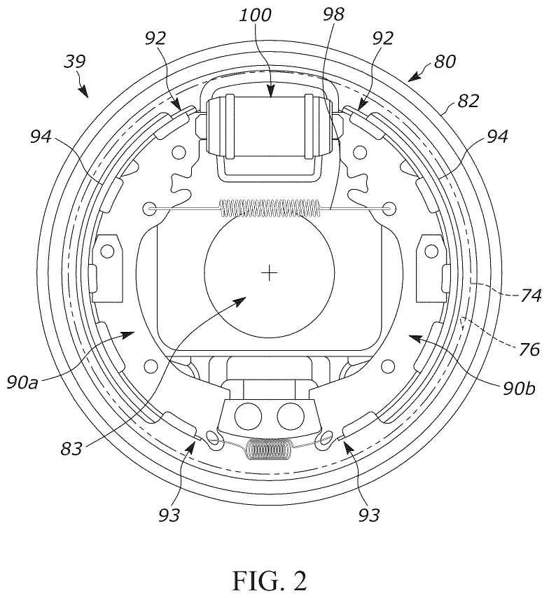

Referring to FIG. 2, the eDrum 39 includes an adapter or backplate assembly 80. The adapter assembly 80 includes a central adapter or backplate 82 having a central opening 83. A pair of brake shoes 90a, 90b is mounted to the back plate 82 on opposite sides of the opening 83 and within the same plane as one another. Each brake shoe 90a, 90b extends from a first end 92 (upper as shown) to a second end 93 (lower as shown). The eDrum 39 is positioned within a brake drum 74 having an inner surface 76 (both illustrated in phantom in FIG. 2) confronting the brake shoes 90a, 90b.

Friction material 94 is secured or bonded to each brake shoes 90a, 90b and has the same shape and general contour as the inner surface 76 of the brake drum 74. A tension spring 98 is connected to each brake shoe 90a, 90b for biasing the brake shoes towards one another.

The brake shoes 90a, 90b are selectively operable between braking and non-braking positions. In the braking position, the brake shoes 90a, 90b contact and press against the inner surface 76 of the brake drum 74 to slow or otherwise stop rotation of the rear wheel 32 (FIG. 1) to which the brake drum is rotationally fixed. In the non-braking position, the brake shoes 90a, 90b do not contact the inner surface 76 of the brake drum 74 and thereby allow the rear wheel 32 to rotate freely.

An actuator 100 is secured to the backplate assembly 80 and positioned generally between the ends 92 of the brake shoes 90a, 90b. The actuator 100 is responsible for displacing the ends 92 for selectively applying the service brake and/or parking brake, as will be discussed.

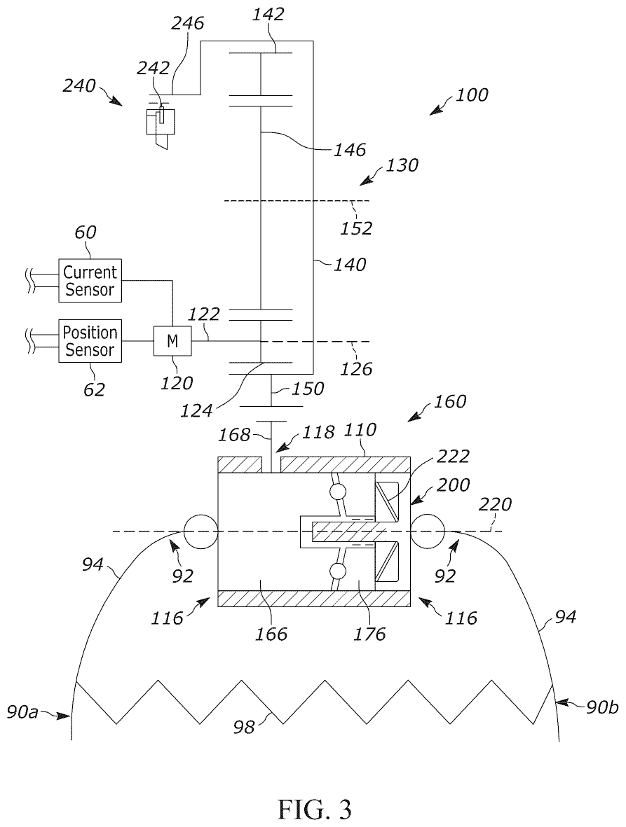

As shown in FIG. 3, the actuator 100 includes a tubular guide 110 fixed to the vehicle 20, e.g., fixed to the backplate assembly 80, and defining an interior space 112. A pair of openings 116 extends through opposite ends of the guide 110 to the interior space 112. Another opening 118 extends radially through the guide 110. The actuator 100 further includes a motor 120 coupled to a gear train 130, e.g., a planetary gear train. In particular, a shaft 122 extends from the motor 120 and has a pinion gear 124 rotatable therewith about an axis 126. A current sensor 60 and rotational position sensor 62 are connected to the motor 120 and to the control system 44 for sending/receiving signals indicative of the motor operation.

The planetary gear train 130 is configured to deliver torque from the motor 120 to at least one ball ramp assembly 160 provided within the guide 110 and aligned with the ends 92 of the brake shoes 90a, 90b. In one example, the planetary gear train 130 includes a carrier 140 connected to planet gears meshed with a sun gear 146 rotatable about an axis 152. In one example, the planet gears include the pinion gear 124 on the motor 120 and another planet gear 142. A torque sensor (not shown) can be provided on the planetary gear train 130 for monitoring the torque delivered to the planetary gear train from the motor 120.

The carrier 140 defines or includes an output gear 150 rotatable therewith and meshed the ball ramp assembly 160 provided in the guide 110. An example ball ramp assembly is shown and described in U.S. patent application Ser. No. 16/157,027, filed Oct. 10, 2018, the entirety of which is incorporated herein by reference. As shown, a single ball ramp assembly 160 is provided in the interior space 112. It will be appreciated, however, that multiple ball ramp assemblies could be longitudinally aligned with one another within the interior space (not shown).

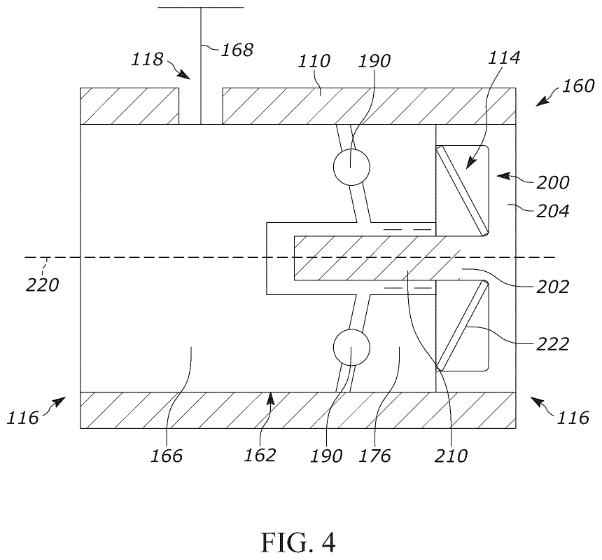

Referring to FIG. 4, the ball ramp assembly 160 includes a nut 162 formed from two separate components, namely, a first ramp 166 and a second ramp 176 longitudinally aligned with one another. Rolling members 190 are provided between the first and second ramps 166, 176. The rolling members 190 can be, for example, ball bearings. The first ramp 166 includes or is integrally formed with a gear 168 for meshed engagement with the carrier 140 of the planetary gear train 130. To this end, the gear 168 extends radially through the opening 118 in the guide 110 and into meshed engagement with the carrier 140. At the same time, the first ramp 166 is axially aligned with and initially spaced from the end 92 of the brake shoe 90a.

The ball ramp assembly 160 further includes a spindle 200 having a shaft 202 extending though the second ramp 176 and into the first ramp 166. More specifically, the shaft 202 has a threaded connection 210 with the second ramp 176 and passes freely into the first ramp 166. A head 204 extends radially from the shaft 202 and is positioned within one of the openings 116 in the guide 110. The head 204 is keyed with the guide 110 or otherwise configured to prevent rotation of the spindle 200. The nut 162 and the spindle 200 are arranged with the guide 110 along a common centerline 220. A biasing member 222 is positioned between the head 204 and the second ramp 176. The biasing member 222 can be, for example, a compression spring or elastomeric member, one or more Belleville washers or the like. In any case, the biasing member 222 axially biases the head 204 and the second ramp 176 away from one another along the centerline 220 to preload the components 176, 200. The head 204 is aligned with and initially spaced from the end 92 of the brake shoe 90b.

Returning to FIG. 3, a bi-stable locking mechanism 240 is provided adjacent to the planetary gear train 130 for selectively preventing torque transfer therethrough. The bi-stable locking mechanism 240 can include a bi-stable solenoid or electromagnet having a positive voltage polarity position and a negative voltage polarity position. In particular, the bi-stable locking mechanism 240 includes a projection 242 (a pin, pawl, etc.) having a first, retracted position spaced from teeth 246 on the carrier 140 and allowing for rotation of the carrier. The projection 242 also has a second, extended position engaged with the teeth 246 for preventing rotation of the carrier 140.

It will be appreciated that the locking mechanism 240 could instead be positioned adjacent any gear in the gear train between the pinion gear 122 and the gear 168 or adjacent the gear 168 itself. In this scenario, the projection 242 has the first and second position relative to the gear train or the gear 168. Regardless, moving the projection 242 to the second position locks the pinion gear 122 by either directly or indirectly preventing rotation thereof.

The projection or pawl 242 can move between the first and second positions by moving axially, rotating and/or pivoting. The control system 44 is connected to and controls operation of the bi-stable locking mechanism 240 by controlling the electrical power supplied thereto. That said, the bi-stable locking mechanism 240 is motor-less, gear-less, and does not require a constant voltage application to maintain any one position.

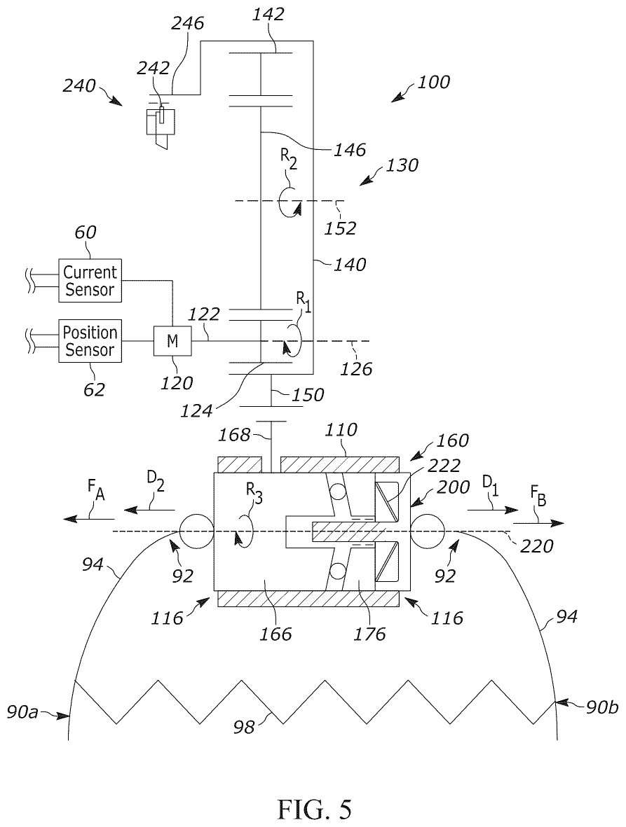

Operation of the brakes is illustrated in FIGS. 5-7. During operation of the vehicle 20, the driver depresses the brake pedal 42 (see also FIG. 1) to operate the disc brake assemblies 39 and apply electromechanical service braking to one or more wheels 30, 32. This will decelerate a moving vehicle, bringing it to a stop such that the vehicle 20 remains stationary on a hill (uphill or downhill). In any case, while the brake pedal 42 remains depressed and the vehicle is stationary, the driver can then apply the parking brake, e.g., electronically, by pushing a button, in which case the locking mechanism 240 engages teeth 246 via the projection 242. Once the teeth 246 are engaged by the pawl 182, electrical power to the motor 120 and to the locking mechanism 240 can be turned off, since the vehicle is successfully parked.

The control system 44 receives signals from one or more of the sensors, e.g., the brake pedal sensor, vehicle speed sensor 50, road grade sensor 52 and/or wheel speed sensor 58, and determines the level of appropriate service braking and whether the parking brake also needs to be applied. Regardless, the control system 44 first actuates the actuator 100 associated with cach rear wheel 32.

To this end, and referring to FIG. 5, the control system 44 actuates the motor 120 to rotate the pinion gear 124 about the axis 126 in the manner R₁ (clockwise as shown). This rotates the sun gear 146 about the axis 152 in the manner R₂, which thereby rotates the output gear 150 in the manner R₂ (counterclockwise as shown). Rotation of the output gear 150 drives rotation of the gear 168 on the ball ramp assembly 160, which thereby rotates the first ramp 166 about the centerline 220 in the manner R₃ (clockwise as shown) relative to the second ramp 176. This causes the rolling members 190 to move up the respective ramps 166, 176 in a known manner. This, in turn, drives the second ramp 176 and the spindle 200 connected thereto away from the first ramp 166 and out of the opening 116 in the direction DI (rightward as shown) towards the end 92 of the brake shoe 90b.

The brake shoes 90a, 90b are initially spaced from the inner surface 76 of the brake drum 74, and, thus, there is little to no initial resistance to outward movement of the brake shoes towards the inner surface 76. Consequently, the brake shoe 90b pivots outward until the friction pad 94 engages the inner surface 76 of the brake drum 74 to apply a braking force FB thereto. This, in turn, imparts a reaction force upon the spindle 200, thereby preventing further movement of the spindle along the centerline 220.

That said, additional rotation of the gear 168 in the manner R₃ causes the rolling members 190 to further separate the ramps 166, 176 by urging the first ramp away from the second ramp. Since the spindle 200 is fixed in place by the reaction forces of the brake drum 74, the first ramp 166 moves in the direction D₂ along the centerline 220. The gear 168 must move laterally with the first ramp 166 in the direction D₂ and, thus, the radial opening 118 in the guide 110 accommodates translation of the gear 168. With this in mind, it will be appreciated that the width of the teeth on the output gear 150 is specifically chosen to be greater than the width of the teeth on the gear 168 to enable the gear 168 to translate across the gear 150 while maintaining meshed engagement therebetween. Alternatively, the width of the teeth on the gear 168 can be greater than the width of the teeth on the output gear 150 (not shown) to accommodate the same movement.

The first ramp 166 moves in the direction D₂ until it engages the end 92 of the brake shoe 90a. Further rotation of the gear 168 from this point causes the first ramp 166 to move the first end 92 of the brake shoe 90a into engagement with the inner surface 76 of the brake drum 74 and apply a braking force F_{A} thereto.

The braking forces F_{A}, F_{B} are maintained on the brake drum 74 until the service braking event ends, such as when the force applied on the brake pedal 42 is released. The force reduction on brake pedal 42 is recognized by the control system 44, which commands the motor 120 to rotate in the opposite direction such that the force applied to brake shoes 90a, 90b is reduced. In particular, and referring to FIG. 5, to reduce force on brake shoes 90a, 90b the motor 120 rotates the pinion gear 124 in a direction opposite to the direction R₁.

This causes the gear 168 and, thus, the first ramp 166 to rotate in a direction opposite to the direction R₃. This, in turn, causes the spindle 200 to be retracted into the nut 162 as the ramps 166, 176 move towards one another. Consequently, the distance between the ends of the brake shoes 90a, 90b is shortened. The tension spring 98 ensures that the brake shoes 90a, 90b are in continuous contact with the ball ramp assembly 160 as it retracts according to the control signal received by the motor 120 from the control system 44. Fully releasing the forces F_{A}, F_{B} on the brake drum 74 means that the brake shoes 90a, 90b are retracted such that some target clearance to the drum inner surface 76 is achieved.

More specifically, the control system 44 receives signals from the sensors 60, 62 and monitors the same during braking events. In this manner, the control system 44 can calculate and monitor the forces F_{A}, F_{B} acting on the brake shoes 90a, 90b and make adjustments to the motor 120 torque and length of the ball ramp assembly 160 in response thereto. The sensors 60, 62 can also allow the control system 44 to monitor the axial position of the spindle 200 before, during, and after braking events. The control system 44 tracks the position of the motor 120 [and therefore the length of the ball ramp assembly 160] such that the target clearance between the brake shoes 90a, 90b and the drum inner surface 76 is known and tracked. When the ball ramp assembly 160 achieves the target clearance level, the control system 44 commands the motor 120 to stop and at the same time (or immediately thereafter) commands the bi-stable locking mechanism 240 to engage the teeth 246 to maintain the target clearance. Power to the motor 120 is then turned OFF.

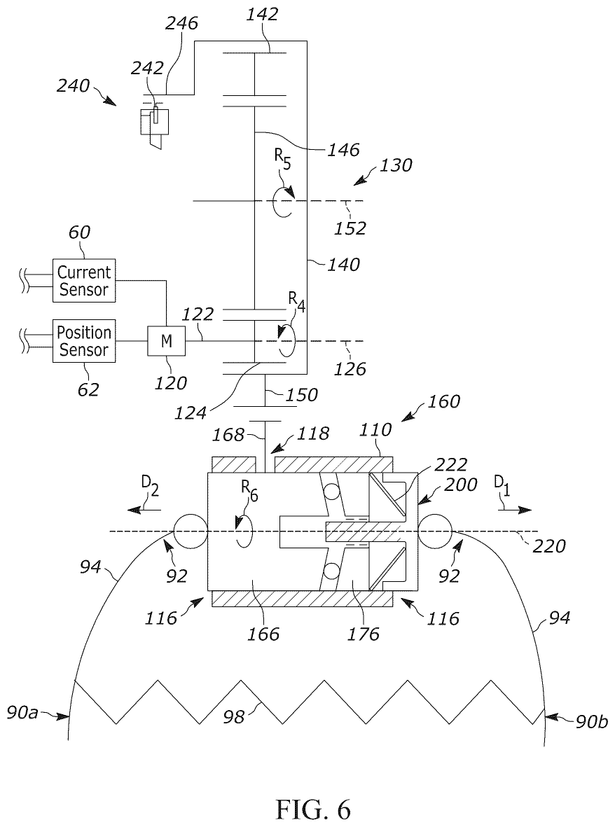

With this in mind, it will be appreciated that the friction material(s) 94 can become worn over time. When this occurs, the target clearance between the brake shoes 90a, 90b and drum inner surface 76 must be maintained. Consequently, when the entire ball ramp assembly 160 (collectively including the ball nut 162 and the spindle 200) is determined by the control system 44 that it will run out of stroke, at the earliest safe opportunity, the control system will command the motor 120 to run in an opposite direction to R₁ (indicated at R₄ in FIG. 6). This, in turn, causes the first ramp 166 to rotate in the direction R₆, and this rotation is continued until the ball ramp 162 is fully retracted to its home position. Continued rotation of the first ramp 166 in the direction R₆ causes the spindle 200 to move in the direction D₁ relative to the nut 162 to adjust for brake shoe 90a, 90b wear.

When the control system 44 tracking the motor 120 position, and thus the spindle 200 position, determines that the target clearance of the brake shoes 90a,90b to the drum surface 74 is achieved, the motor 120 is stopped, ending the brake shoe wear adjustment. Note that while the spindle 200 is moving in direction D₁ and is adjusted for pad wear, the biasing member 222 continues to apply some minimal force between the spindle 200 and the ramp 176. This minimal force application ensures the spindle 200 and ramp 176 remain locked through their thread engagement during normal service brake events of the eDrum 39, i.e., the biasing member 222 has sufficient stroke and force application to prevent relative rotation between the spindle and the ramp during brake events. The biasing member 222 is designed in such a way to perform its function (to preload the components 176, 200) whether the brake shoes 90a, 90b are new or fully worn.

To this end, as noted, the biasing members 222 axially bias the spindle 200 away from the nut 162. The biasing members 222, however, prevent rotation of the spindle 200 in a manner that translates the spindle 200 away or towards the ball ramp 176 outside of wear adjustment events. In other words, the biasing members 222 provides a constant load at the interface 210 between the spindle 200 and the ball ramp 176 in a manner that prevents relative rotation therebetween during service brake apply and release events. Consequently, once the spindle 200 is advanced axially relative to the nut 162 (to accommodate wear on the brake shoes 90a, 90b), this becomes the new default condition from which subsequent braking events begin-the overall length of the combined second ramp 176 and spindle 200 does not decrease.

When a subsequent service braking operation is triggered after the wear adjustment operation detailed above, the ball ramp assembly 160 position is as shown in FIG. 4, i.e., fully retracted (at home position) Consequently, the ball ramp assembly 160 can extend/lengthen to apply the braking forces F_{A}, F_{B} to the brake drum 74 in a timely manner.

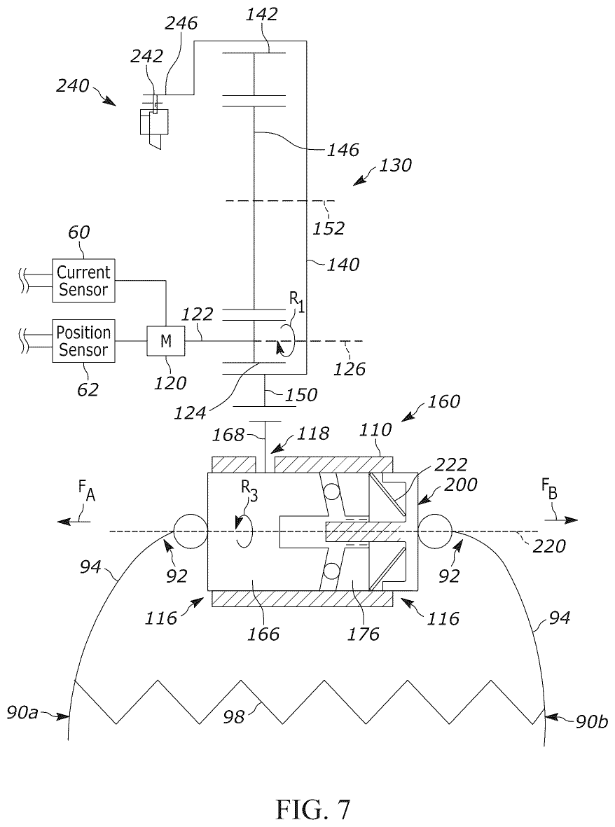

In either scenario shown in FIG. 5 or FIG. 6, when it is desirable to apply the parking brake (FIG. 7), the actuator 100 is actuated until the control system 44 estimates that the target braking force is achieved, at which point the motor is held powered but stationary. Then the control system 44 directs electrical power of polarity A to the locking mechanism 240. This causes the projection 242 to translate into engagement with the teeth 246 and thereby prevent rotation thereof. The control system 44 reduces the torque demand from the motor 120 until the current draw on the motor 120 suddenly drops to zero, confirming that the carrier 140 is locked. This advantageously allows the braking forces F_{A}, F_{B} to be maintained without relying on torque applied by a powered motor. In other words, the braking forces Fa, Fb are maintained with an unpowered motor. Power to the locking mechanism 240 is removed to automatically lock the projection 242 in engagement with the teeth 246.

The brake drum 74, in turn, exerts reaction forces on the brake shoes 90a, 90b. The reaction forces are transferred from the friction pads 94, to the ends 92 of the brake shoes 90a, 90b, and ultimately to the ball ramp assembly 160. Consequently, the locked nut 162 and spindle 200 oppose the reaction forces applied by the brake drum 74 to the brake shoes 90a, 90b. These reaction forces, in turn, and transferred to the planetary gear train 130, which is locked by the locking mechanism 240.

To release the parking brake, the control system 44 commands the motor 120 to rotate in direction Ri until the motor supports the full torque due to force on brake shoes 90a, 90b. The motor 120 is then held powered and stationary and the control system 44 also directs electrical power of polarity B to the locking mechanism 240 to cause the projection 242 to retract out of engagement with the teeth 246.

The control system 44 then ceases power supply to the locking mechanism 240 while reducing torque to the motor 120, which will cause the motor 120 to rotate in a direction opposite the direction R₁ (counterclockwise as shown) to cause the actuator 100 to retract until the target clearance between the brake shoes 90a, 90b and the drum inner surface 76 is achieved. More specifically, the ramps 166, 176 move towards one another as the rolling members 190 come off the ramps. This removes the forces F_{A}, F_{B} on the brake shoes 90a, 90b while allowing the tension spring 98 to maintain contact between the brake shoes 90a, 90b and the ball ramp assembly 160 at all times. After the ramps 166, 176 fully retract (at home position) the motor 120 is stopped and powered off.

It will be appreciated that the present invention has been shown and described as operating with the brake shoe 90b engaging the brake drum 74 first, followed by the brake shoe 90a. The order of engagement between the brake shoes 90a, 90b and the brake drum 74, however, can be reversed. In other words, the first ramp 166 can move the brake shoe 90a to apply the braking force F_{A}, followed by the spindle 200 moving the brake shoe 90b to apply the braking force F_{B}. In either case, the opening 118 in the guide 110 accommodates lateral movement of the gear 168 in either direction and the guide helps maintain positioning of the ball ramp assembly 160 relative to the ends 92.

It will also be appreciated that although a single ball ramp assembly 160 is shown the guide 110 could instead accommodate a pair of ball ramp assemblies driven by a pair of output gears 150 on the planetary gear train 140 (not shown). In this construction, a gear 168 is provided on each nut 162 and extends through a respective opening 118 in the guide 110 to allow cach nut to translate relative to the output gear 150 engaged therewith during application/release of the service brake. In this dual ball ramp assembly configuration, the bi-stable locking mechanism 240 would operate in the same manner to lock the carrier 140, thereby simultaneously locking both output gears 150 (not shown). The above paragraphs describing the operation of the eDrum 39 in FIGS. 3-7 and, in particular, the wear adjustment operation, are also covered in U.S. Pat. No. 11,511,715, the entirety of which is incorporated herein by reference.

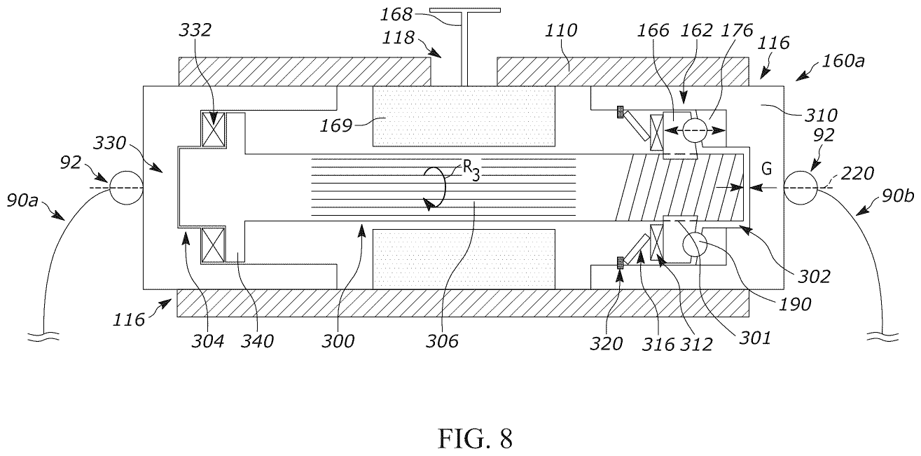

Another example ball ramp assembly (or ball ramp and clevis assembly) 160a is illustrated in FIG. 8. Features in FIG. 8 that are similar to those found in FIGS. 1-7 are given the same reference number. In FIG. 8, the ball ramp assembly 160a includes the nut 162 and rolling members 190. A spindle 300 extends longitudinally through the guide 110 from a first end 302 to a second end 304. The first end 302 is threaded to the first ramp 166 of the nut 162 at a threaded interface 301.

A first clevis 310 extends over the first end 302 of the spindle 300 and abuts the second ramp 176. The first clevis 310 is initially longitudinally spaced from the first end 302 by a gap G. The first clevis 310 is slidably received in the guide 110 in a manner that prevents rotation of the first clevis about the centerline 220. Rotation of the clevises 310 and 330 is typically prevented by the brake shoes 90b, 90a respectively (see FIG. 2). A thrust bearing 312 abuts the first ramp 166 and is biased into engagement therewith by a biasing member 316. The biasing member 316 can be, for example, a compression spring or elastomeric member, one or more Belleville washers or the like. The biasing member 316, in turn, is retained by a clip or circlip 320 positioned within a groove in the clevis 310. That said, the thrust bearing 312, biasing member 316, and circlip 320 cooperate to preload the components 310, 166.

A second clevis 330 extends over and abuts the second end 304 of the spindle 300. A thrust bearing 332 is sandwiched between the second clevis 330 and a radially extending projection 340 of the spindle 300. The second clevis 330 and thrust bearing 332 can be considered part of the ball ramp assembly 160a or supplemental components added/connected thereto. In any case, the spindle 300 further includes a splined portion 306 between the ends 302, 304 and splined for rotation with a gear 169 encircling the splined portion within the guide 110. The gear 169 includes the gear 168 extending radially through the opening 118 in the guide 110 and into meshed engagement with the carrier 140 via gear 150.

The ball ramp assembly 160a operates in cooperation with spindle 300 via the threaded interface 301 therebetween to automatically account for wear on the brake shoes 90a, 90b by moving in a manner to increase the gap G by moving in direction D1, thereby maintaining the target clearance between the brake shoes and the inner surface 76 of the brake drum 70 after every service brake apply event.

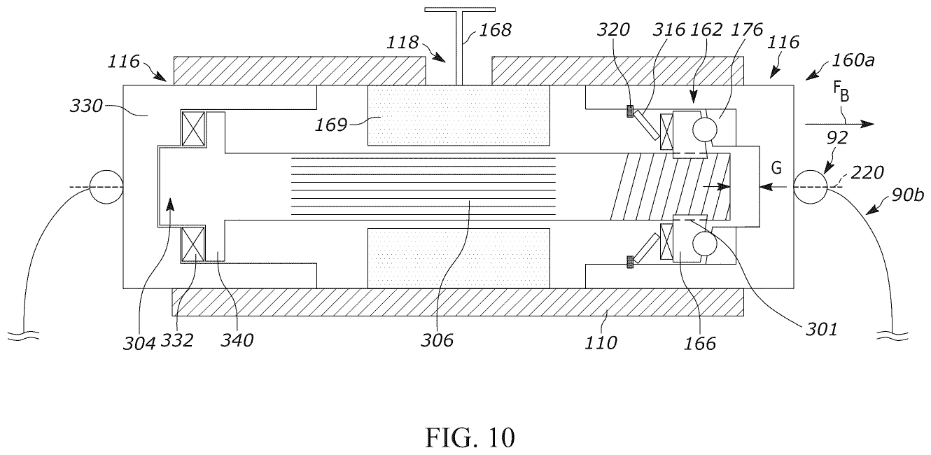

To this end and referring to FIG. 10, the threaded interface 301 between the spindle 300 and the first ramp 166, is lower efficiency than the efficiency of the ball ramp 162. In other words, rotation of the spindle 300 in the direction R₃ first causes the nut 162 to translate in relation to/along the spindle 300 before the ramps 166, 176 move relative to eachother when a relatively lower or no reaction force is applied to the first clevis 310. That said, in the absence of sufficient reaction force on the first clevis 310, the nut 162 translates in the direction DI without the ball ramp assembly 160a opening up. During this time, however, the brake shoes 90b, 90a are moved toward the drum surface 74.

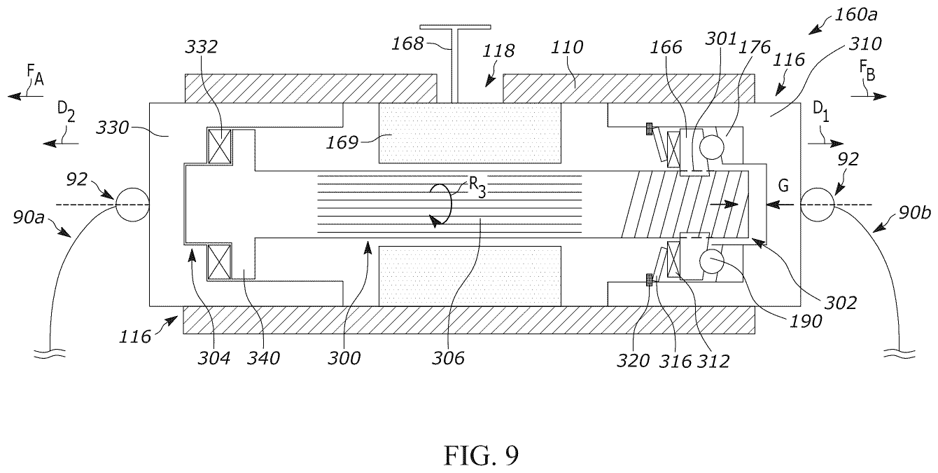

If service braking begins when the brake shoes 90a, 90b are at the target clearance, rotation of the spindle 300 in the direction R₃ will result in the translation of the nut 162 before the ramps 166, 176 begin separating to apply the service brake (FIG. 9). More specifically, when service braking is requested the spindle 300 is rotated in the manner R₃, thereby causing the ball ramp assembly 160a to move as an assembly in the direction DI until contact with brake shoe 90b is achieved. Continued rotation of the spindle 300 will then cause the spindle to move in direction D₂ until the clevis 330 contacts the brake shoe 90a. Continued rotation of the spindle 300 causes the spindle 300 and ball ramp assembly 160a to continue to move the brake shoes 90a, 90b into contact with the drum surface 74. Continued rotation of the spindle 300 will then increase the load in the threaded interface 301 between the spindle 300 and the ramp 166 to lock, thereby forcing the ball ramps 166 and 176 to separate, applying force on brake shoes 90a, 90b toward the target force requested via the brake pedal.

It will be appreciated that the biasing force of the biasing member 316 is such that the spring can be compressed/collapsed as the first clevis 310 moves in the direction D₁. In other words, the biasing member 316 does not materially restrain or prevent movement of the first clevis 310 in the direction D₁. That said, the reaction force from the brake drum 74 prevents further movement of the first clevis 310.

Further rotation of the first ramp 166 in the manner R₃ causes the ramps 166, 176 to move further apart from one another. Due to the reaction force applied to the first clevis 310, however, the first clevis and second ramp 176 remain in place while the first ramp 166 moves in the direction D₂ away from the second ramp. In other words, the ramps 166, 176 continue separating from one another but with the first clevis 310/ramp 176 being prevented from further movement in the direction DI the first ramp 166 and spindle 300 are caused to move together as a single unit in the direction D₂ away from the first clevis/ramp 176. This movement is facilitated by the splined interface between the portion 306 of the spindle 300 and the gear 169.

The spindle 300 moving in the direction D₂ acts on the thrust bearing 332 to thereby move the second clevis 330 in the direction D₂ to thereby move the end of the brake shoe 90a into engagement with the inner surface 76 of the brake drum 74. Consequently, the lengthened ball ramp assemblya 160 applies the braking forces F_{A}, F_{B} to the brake drum 74 so long as the braking event is desired.

When service braking is released, the gear 169 is rotated in the opposite direction to reverse the process and allow the ramps 166, 176 to return to their original positions of FIG. 8. That is, the ball ramps 166, 176 return to the home position with continued gear 169 rotation and, thus, the ball ramp assembly 160a is retracted in the opposite direction to D₁ via threaded interface 301 until the target clearance between the brake shoes 90a, 90b is achieved. The gear 169 is stopped by stopping and powering off the motor 120. The tension spring 98 helps facilitate this return.

To park the vehicle, when the eDrum 39 is applied to the desired forces on the brake shoes 90a, 90b with forces Fa, Fb, the motor 120 is stopped but still powered to maintain the required torque to apply forces Fa, Fb. Next, the locking mechanism 240 is activated to engage the teeth 246. The motor 120 power is reduced which thereby reduces the torque applied by the motor 120 to the gears. Consequently, the parking torque is transferred to the locking mechanism 240 engaged with the teeth 246. When the motor 120 torque reduces to zero, the full reversing torque required to maintain forces Fa, Fb is held by the locking mechanism 240 and teeth 246. At this point, the motor 120 and locking mechanism 240 are both powered off.

When the entire nut 162 translates along the spindle 300, it does so as long as the forces on the clevises 310, 330 is/are below a threshold force determined by the biasing member 316 preload. Additional force generated at clevises 310, 330 above the threshold force locks the ramp 166 to the spindle 300 via the threaded interface 301, and now the ramp 166 rotates together with spindle 300, extending the ball ramps 166 and 176 away from each other.

Once the target force Fa, Fb are met, the service brake can be held, released or parked. If service braking is no longer desired, reversing rotation of the motor 120 causes the spindle 300 and first ramp 166 to rotate in the opposite direction, and the second ramp 176 to move towards the first ramp 166, allowing the brake shoes 90a, 90b to move off the brake drum 74 under the bias of the spring 98.

That said, the ramps 166, 176 return to their initial condition relative to one another (ball ramp home position) but the entire nut 162 is now positioned closer to the first end 302 of the spindle 300—the entire ball ramp assembly 160a, spindle 300 and clevis 330 stopping somewhat lengthened due to brake shoe wear. This process can be repeated as the brake shoes 90a and/or 90b continue to wear such that the same target clearance is provided between the brake shoes and the brake drum 74 prior to the start of every braking event.

The present invention is advantageous in that enables the actuator to operate entirely electromechanically (including both service and parking brake operation). The bi-stable locking mechanism advantageously helps to provide secure locking and release of the parking brake while the guide accommodates the reaction forces borne by the ball ramp assembly during application of the service brake. The ball ramp assembly provides a high mechanical efficiency to application of the service brake and the biasing member allows the ball ramp assembly to adapt to wear on the brake shoes over time.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An apparatus for a brake drum having a drum brake assembly with first and second brake shoes, comprising:
a motor;
a planetary gear train for receiving torque from the motor and having a pinion gear;
a ball ramp assembly for receiving torque from the pinion gear and having ends aligned with the respective first and second brake shoes, the motor being actuatable for lengthening the ball ramp assembly to move the brake shoes and apply braking force to the brake drum; and
a bi-stable locking mechanism for selectively locking the planetary gear train to apply a parking brake to the brake drum.

2. The apparatus recited in claim 1, wherein the ball ramp assembly comprises a spindle splined to a gear for receiving torque from the pinion gear, a nut threaded with the spindle, and a clevis connected to the nut, wherein the motor is actuatable for rotating the spindle to translate the ball ramp assembly on the spindle and thereby move the brake shoes to apply braking force to or release braking force from the brake drum.

3. The apparatus recited in claim 2, wherein the nut comprises:
a first ramp for receiving torque from the spindle;
a second ramp unthreaded with the spindle and movable with the clevis;
a biasing member, a circlip, and thrust bearing for preloading the first and second ramps, and
rolling members provided between the first and second ramps, wherein rotation of the first ramp relative to the second ramp causes the rolling elements to push the second ramp away from the first ramp to move the clevis away from the spindle, wherein rotation of the first ramp with the second ramp causes the nut and the clevis to advance relative to the spindle to account for wear on the brake shoes.

4. The apparatus recited in claim 1, wherein the ball ramp assembly comprises a nut having a gear for receiving torque from the pinion gear and a spindle threaded with the nut and splined to the gear, the nut being aligned with the first brake shoe and the spindle being aligned with the second brake shoe, the motor being actuatable for rotating the nut to move the nut and the spindle away from one another for moving the brake shoes to apply braking force to the brake drum.

5. The apparatus recited in claim 4, further comprising a guide fixed to the vehicle and receiving the ball ramp assembly, the gear on the nut extending through an opening in the guide for connecting to an output gear receiving torque from the pinion gear.

6. The apparatus recited in claim 5, wherein the opening allows the gear to move longitudinally relative to the output gear to accommodate relative movement between the nut and the spindle.

7. The apparatus recited in claim 5, wherein the nut comprises:
a first ramp for receiving torque from the output gear;
a second ramp having a threaded connection with the spindle;
a biasing member for preloading the spindle relative to the second ramp and
rolling members provided between the first and second ramps, wherein rotation of the first ramp relative to the second ramp causes the rolling elements to push the second ramp away from the first ramp, wherein rotation of the first ramp with the second ramp causes the spindle to advance relative to the second ramp.

8. The apparatus recited in claim 1, wherein the bi-stable locking mechanism has a first condition engaging the planetary gear train for locking the same in response to receiving electrical power of a first polarity and having a second condition retracted from the planetary gear train for allowing rotation of the same in response to receiving electrical power of a second polarity.

9. The apparatus recited in claim 1, wherein the bi-stable locking mechanism includes a projection that moves relative to the planetary gear train between the first condition and the second condition.

10. The apparatus recited in claim 1, further comprising a return spring configured to be connected to both brake shoes for biasing the brake shoes towards one another.

11. An apparatus for a brake drum having a drum brake assembly with first and second brake shoes, comprising:
a motor;
a planetary gear train for receiving torque from the motor and having an output gear;
a ball ramp assembly comprising a spindle for receiving torque from the output gear, a nut threaded with the spindle, and a clevis connected to the nut, wherein the motor is actuatable for rotating the spindle to move clevis away from the spindle and thereby move the brake shoes to apply braking force to the brake drum;
a biasing member for biasing the nut away from the spindle to automatically respond to wear on the brake shoes; and
a bi-stable having a first condition engaging the planetary gear train for locking the same in response to receiving electrical power of a first polarity and having a second condition retracted from the planetary gear train for allowing rotation of the same in response to receiving electrical power of a second polarity.

12. The apparatus recited in claim 11, wherein the nut comprises:
a first ramp for receiving torque from the spindle;
a second ramp unthreaded with the spindle and movable with the clevis;
a biasing member, a circlip, and thrust bearing for preloading the first and second ramps; and
rolling members provided between the first and second ramps, wherein rotation of the first ramp relative to the second ramp causes the rolling elements to push the second ramp away from the first ramp to move the clevis away from the spindle, wherein rotation of the first ramp with the second ramp causes the nut and the clevis to advance relative to the spindle to account for wear on the brake shoes.

13. The apparatus recited in claim 11, wherein the bi-stable locking mechanism includes a projection that moves axially relative to the planetary gear train between the first condition and the second condition.

14. The apparatus recited in claim 11, further comprising a return spring configured to be connected to both brake shoes for biasing the brake shoes towards one another.
